(19) United States
(12) Patent Application Publication
(10) Pub. No.: US 2026/0288967 A1
(43) Pub. Date: Sep. 24, 2026

(54) DISMISSING INTERFACE ELEMENTS USING ARTIFICIAL INTELLIGENCE

(71) Applicant: Black Duck Software, Inc., Burlington, MA (US)

(72) Inventor: James Edward RICHARDSON, Houston, TX (US)

(21) Appl. No.: 19/083,106

(22) Filed: Mar. 18, 2025

(51) Int. Cl. G06F 21/57; G06T 7/70

(52) U.S. Cl. CPC G06F 21/577; G06T 7/70; G06F 2221/033; G06T 2207/20081

(57) ABSTRACT

Described herein is a computer system for dismissing user interface elements. The computer system includes one or more memories and one or more processors communicatively coupled to the one or more memories. The one or more processors, individually or collectively, perform an operation that includes receiving an image of an element of a user interface and determining a location of the element in the user interface. The operation also includes determining, using a machine learning model and based on the image of the element and the location of the element in the user interface, a user action for dismissing the element from the user interface and performing the user action on the element to dismiss the element from the user interface.

### TECHNICAL FIELD

The present disclosure relates to dismissing elements from user interfaces.

### BACKGROUND

User interfaces (e.g., websites) may include elements with which users may interact (e.g., click, type, drag, scroll, etc.). Some interfaces include elements that prevent users from interacting with portions of the interfaces until the elements have been dismissed from the interfaces by performing certain user actions on the elements.

### SUMMARY

The present disclosure describes a computer system for dismissing user interface elements. The computer system includes one or more memories and one or more processors communicatively coupled to the one or more memories. The one or more processors, individually or collectively, perform an operation that includes receiving an image of an element of a user interface and determining a location of the element in the user interface. The operation also includes determining, using a machine learning model and based on the image of the element and the location of the element in the user interface, a user action for dismissing the element from the user interface and performing the user action on the element to dismiss the element from the user interface.

The operation may include receiving an image of the user interface that includes the element. Determining the user action may be further based on the image of the user interface.

The operation may include receiving a list of user actions. Determining the user action may include selecting the user action from the list of user actions.

The operation may include receiving an image of the user interface with the element dismissed. Determining the user action may be further based on the image of the user interface with the element dismissed.

Determining the user action may include generating a prompt based on the image of the element and the location of the element in the user interface and directing the prompt to the machine learning model.

The user interface may be a website.

The operation may include scanning the user interface after dismissing the element to detect a security risk in the user interface.

The element may prevent interaction with a portion of the user interface until the element is dismissed from the user interface.

The operation may include scanning the user interface to detect the element.

According to another embodiment, a method includes receiving an image of an element of a user interface and determining a location of the element in the user interface. The method also includes determining, using a machine learning model and based on the image of the element and the location of the element in the user interface, a user action for dismissing the element from the user interface and performing the user action on the element to dismiss the element from the user interface.

The method may include receiving an image of the user interface that includes the element. Determining the user action may be further based on the image of the user interface.

The method may include receiving a list of user actions. Determining the user action may include selecting the user action from the list of user actions.

The method may include receiving an image of the user interface with the element dismissed. Determining the user action may be further based on the image of the user interface with the element dismissed.

Determining the user action may include generating a prompt based on the image of the element and the location of the element in the user interface and directing the prompt to the machine learning model.

The user interface may be a website.

The method may include scanning the user interface after dismissing the element to detect a security risk in the user interface.

The element may prevent interaction with a portion of the user interface until the element is dismissed from the user interface.

The method may include scanning the user interface to detect the element.

According to another embodiment, a non-transitory computer readable medium stores instructions for dismissing user interface elements that, when executed by one or more processors, cause the one or more processors to, individually or collectively, perform an operation that includes receiving a first image of an element of a website and receiving a second image of the website comprising the element. The operation also includes determining a location of the element in the website and receiving a list of user actions. The operation further includes determining, using a machine learning model and based on the first image, the second image, the location of the element in the website, and the list of user actions, a user action for dismissing the element from the website and performing the user action on the element to dismiss the element from the website.

Determining the user action may include generating a prompt based on the first image, the second image, the location of the element in the website, and the list of user actions and directing the prompt to the machine learning model.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an example operation for determining a security risk performed by a computer system.

FIG. 2 illustrates an example operation for detecting elements of a user interface performed by a computer system.

FIG. 3 illustrates an example operation for generating images of a user interface performed by a computer system.

FIG. 4 illustrates an example operation for determining a user action performed by a computer system.

FIG. 5 illustrates an example operation for determining a security risk performed by a computer system.

FIG. 6 is a flowchart of an example method for determining a security risk performed by a computer system.

FIG. 7 depicts a diagram of an example computer system in which embodiments of the present disclosure may operate.

### DETAILED DESCRIPTION

Aspects of the present disclosure relate to dismissing elements from a user interface using artificial intelligence. One technique used to detect security risks presented by a user interface (e.g., a website) is to use a security application to scan or crawl the interface. An interface, however, may include an element that prevents interactions with a portion of the interface until the element is dismissed (e.g., by clicking, dragging, scrolling, etc. on a portion of the element). For example, the element may present a warning message or request authorization to collect user data, and the element may prevent interactions with the rest of the interface until the element is acknowledged (e.g., by clicking a button on the element). An application that scans or crawls the user interface to detect security risks, however, may not interact with the element to dismiss the element, which effectively prevents the application from scanning or crawling the interface.

The present disclosure describes a computer system that uses artificial intelligence to dismiss an element from a user interface. The computer system may generate or receive images of the user interfaces and elements in the user interface. The computer system may also determine other information about the interface (e.g., the location of the elements in the interface, a list of potential user actions that can be performed on the interface, etc.). The computer system may use the images and the information to generate a prompt to request dismissal of an element in the interface. The computer system may direct the prompt to a machine learning model, and the machine learning model may use the information in the prompt to determine one or more user actions that should be performed to dismiss the element from the interface. The computer system may then perform the determined user actions to dismiss the element from the interface.

In particular embodiments, the computer system provides several technical advantages. For example, the computer system may automatically determine and perform user actions to dismiss an element from a user interface. As a result, the computer system may scan or crawl the user interface to detect security risks presented by the user interface, which may go undetected using existing computer systems.

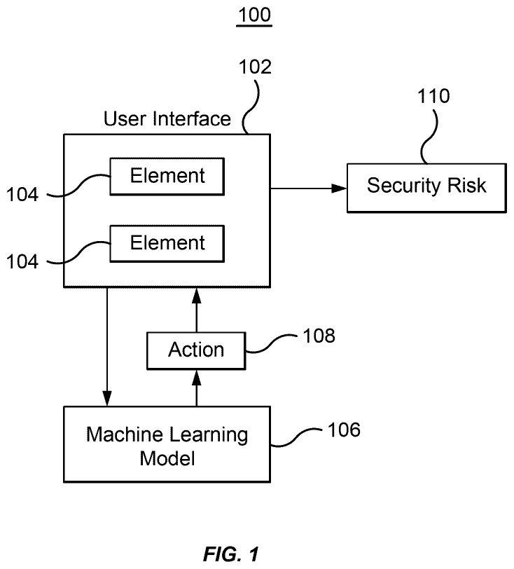

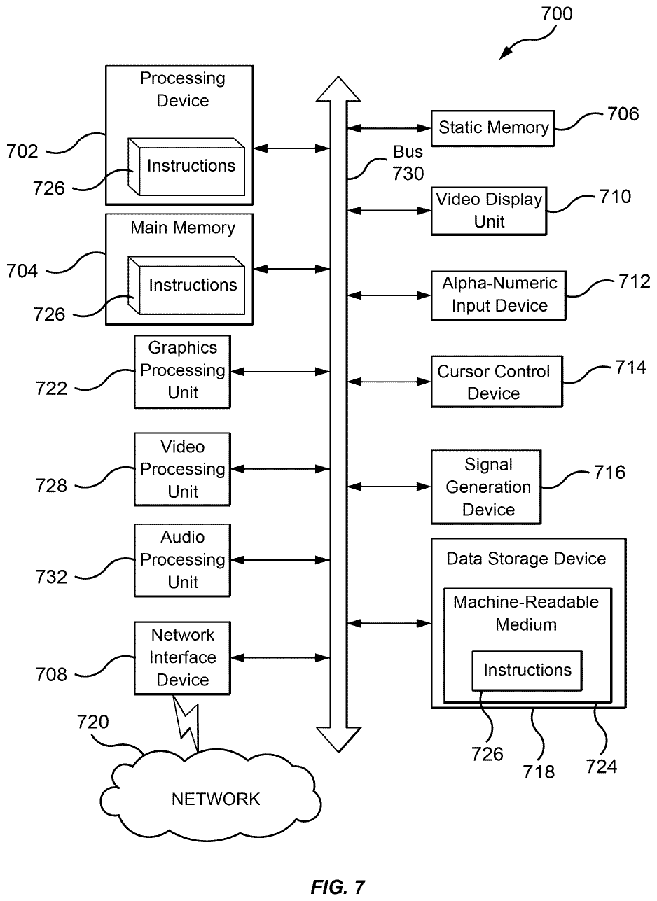

FIG. 1 illustrates an example operation 100 for determining a security risk performed by a computer system (e.g., the computer system 700 shown in FIG. 7). Generally, the computer system dismisses elements from a user interface (e.g., a website) and then scans the user interface to determine a security risk presented by the user interface.

The computer system begins by receiving and/or presenting a user interface 102. For example, the computer system may receive a link to and/or a file for the user interface 102. The user interface 102 may be any interface with which a user may interact. For example, the user interface 102 may be an application interface, a web interface (e.g., a website, webpage, etc.), a cloud interface, etc. The user interface 102 may be a graphical interface that includes a number of elements 104, which may be considered graphical elements of the user interface 102. The elements 104 may include one or more of images, text, textboxes, buttons, lists, links, etc. The elements 104 may be presented or displayed when the user interface 102 is presented or displayed.

In some instances, an element 104 (which may be referred to as a modal element) may prevent or block user interaction with other portions (e.g., other elements 104) of the user interface 102 until the element 104 is dismissed (e.g., cleared and/or removed from the display). For example, some websites may present a message or notification that seeks approval for collecting information for cookies. Until the user interacts with a button or link accompanying the message or notification, the website blocks or prevents the user from interacting with other portions of the website. When the user interacts with the button or link, the message or notification may be dismissed or cleared from the display, and the website may allow the user to interact with other portions of the website.

Due to the element 104 preventing or blocking interaction with other portions of the user interface 102, the element 104 may prevent the computer system from successfully scanning or crawling the user interface 102 to detect security risks presented by the user interface 102. The computer system may use a machine learning model 106 to determine an action 108 to perform on the element 104 to dismiss or clear the element 104. The computer system may then scan or crawl the user interface 102 to determine a security risk 110 presented by the user interface 102.

The computer system may provide the machine learning model 106 information about the user interface 102 and the elements 104 of the user interface 102 so that the machine learning model 106 may predict the action 108 that is needed to dismiss or clear the element 104 that prevents or blocks interaction with other portions of the user interface 102. For example, the computer system may generate images or screenshots of the user interface 102 and the elements 104 of the user interface 102. The computer system may also determine locations (e.g., coordinates, path, XPath, Cascading Style Sheets (CSS) selector, etc.) of the elements 104 in the user interface 102. The computer system may also be provided a list of user actions (e.g., click, drag, highlight, etc.) that can be used to interact with the elements 104 in the user interface 102.

The computer system may direct the images of the user interface 102 and the elements 104, the locations of the elements 104, and the list of user actions to the machine learning model 106. For example, the computer system may generate a prompt that provides the images, the locations, and the list of user actions. The prompt may also request the machine learning model 106 to predict the action 108 from the list of actions that will dismiss or clear an element 104 from the user interface 102 so that the element 104 stops preventing or blocking user interaction with the user interface 102. The machine learning model 106 may respond to the prompt by determining or predicting the action 108. The computer system may then perform the action 108 on the element 104 in the user interface 102 to dismiss or clear the element 104.

After dismissing or clearing the element 104, the computer system may scan or crawl the user interface 102 to detect the security risk 110 presented by the user interface 102. The scanning or crawling may involve the computer system testing or interacting with the other elements 104 remaining in the user interface 102. Through the testing or interactions, the computer system may identify the security risk 110 presented by using the user interface 102. Therefore, by using the machine learning model 106 to determine the action 108, the computer system may automatically dismiss or clear the element 104, which allows the computer system to proceed with scanning or crawling the user interface 102.

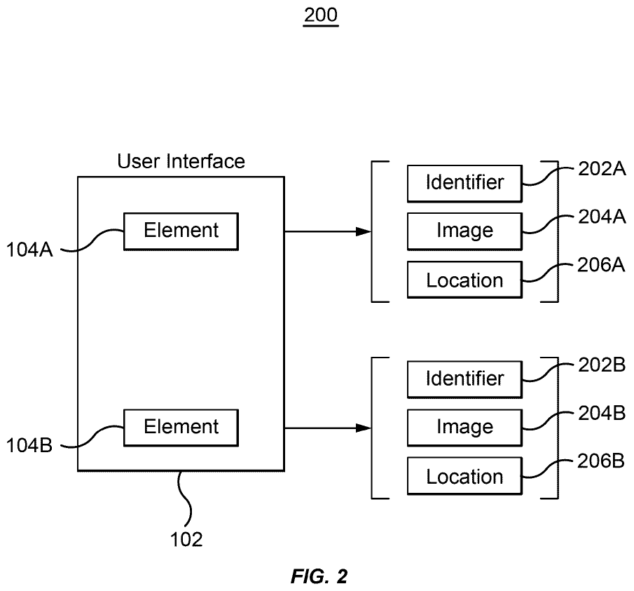

FIG. 2 illustrates an example operation 200 for detecting elements of a user interface performed by a computer system (e.g., the computer system 800 shown in FIG. 7). Generally, the computer system performs the operation 200 to determine information for elements of a user interface.

The computer system begins by scanning or analyzing the user interface 102, which may include the elements 104A and 104B. The elements 104A and 104B may be positioned at different locations on the user interface 102. Additionally, the element 104A may prevent or block interaction with other portions of the user interface 102 (e.g., the element 104B). Although the element 104B may be presented and visible, the user interface 102 may block or prevent interaction with the element 104B until the element 104A has been dismissed or cleared from the user interface 102.

By scanning or analyzing the user interface 102, the computer system detects the elements 104A and 104B and determines information about the elements 104A and 104B. For example, when detecting the elements 104A and 104B, the computer system may determine or assign identifiers 202 to the elements 104A and 104B. In the example of FIG. 2, the computer system determines the identifier 202A for the element 104A and the identifier 202B for the element 104B. After detecting the elements 104A and 104B, the computer system may generate images 204 of the elements 104A and 104B. In the example of FIG. 2, the computer system generates the image 204A for the element 104A and the image 204B for the element 104B. The computer system may also determine the locations 206 of the elements 104A and 104B in the user interface 102. In the example of FIG. 2, the computer system determines the location 206A of the element 104A and the location 206B of the element 104B. As discussed above, the locations 206A and 206B may include one or more of coordinates, paths, XPaths, CSS selectors, etc. of the elements 104A and 104B.

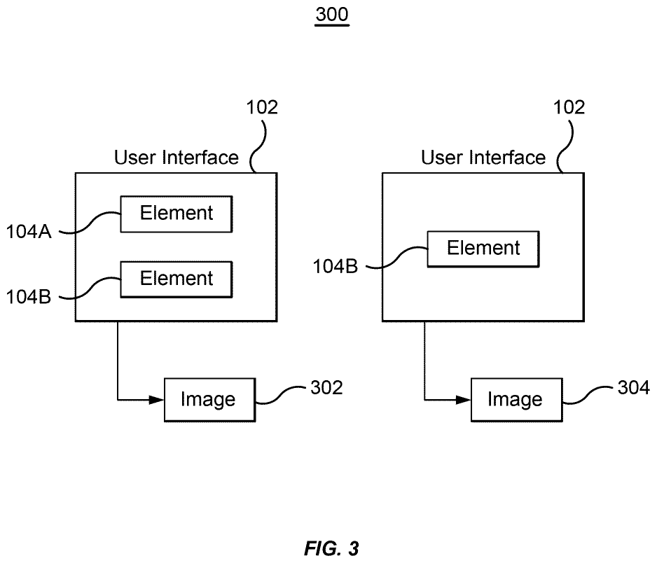

FIG. 3 illustrates an example operation 300 for generating images of a user interface performed by a computer system (e.g., the computer system 800 shown in FIG. 7). As seen in FIG. 3, the computer system begins by generating an image 302 of the user interface 102 when the elements 104A and 104B appear in the user interface 102. For example, the computer system may capture a screenshot of the user interface 102, which serves as the image 302. As a result, the image 302 may depict the user interface 102 along with the elements 104A and 104B.

In some embodiments, the computer system also generates an image of the user interface 102 when the user interface 102 is in a desired end state. In the example of FIG. 3, the computer system generates an image 304 of the user interface 102 when the element 104A is removed from the user interface 102. For example, if the computer system determines or understands that the element 104A is preventing or blocking interaction with the user interface 102 (e.g., if a user of the computer system indicates that the element 104A is blocking or preventing interaction with the user interface 102), then the computer system may generate the image 304 of the user interface 102 with the element 104A removed.

In some instances, the computer system may not determine or know the desired end state for the user interface 102. As a result, the computer system may not generate the image 304 of the user interface 102. Instead, the computer system may rely on the machine learning model to predict which element of the user interface is blocking or preventing interaction with the user interface and which user action will dismiss or clear the element.

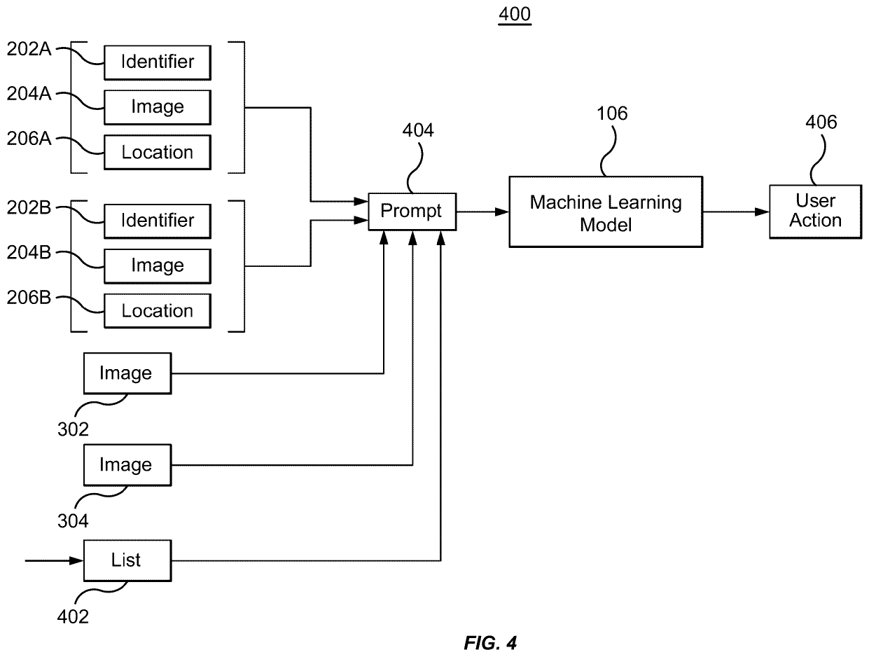

FIG. 4 illustrates an example operation 400 for determining a user action performed by a computer system (e.g., the computer system 800 shown in FIG. 7). The computer system begins with the information about the user interface and/or the elements of the user interface. In the example of FIG. 4, the computer system begins with the identifier 202A, image 204A, and location 206A of a first element of the user interface and the identifier 202B, image 204B, and location 206B of a second element of the user interface. The computer system also begins with the image 302 of the user interface, which may depict the first and second elements.

In some embodiments, the computer system also begins with the image 304 that shows the desired end state of the user interface (e.g., depicting the user interface with the first element dismissed or cleared). In some instances, the computer system may not begin with the image 304 if the computer system does not determine or understand the desired end state of the user interface.

A user may also provide the computer system with a list 402 of potential user actions that may be performed in the user interface. For example, the list 402 may include a set of user actions (e.g., click, drag, highlight, etc.) that may be performed on the elements of the user interface. The user action that may dismiss or clear the first element from the user interface may be included in the list 402.

The computer system generates a prompt 404 using the information about the user interface and/or the elements of the user interface. For example, the prompt 404 may be a request to predict the user action (e.g., from the list 402) that will dismiss one or more elements from the user interface such that these elements do not block or prevent interaction with the user interface. The prompt 404 may reference the information (e.g., the identifiers 202, images 204, and locations 206 of the elements, the images 302 and 304 of the user interface, and/or the list 402). In instances where the computer system does not have the image 304, the prompt 404 may not reference the image 304. The computer system then directs the prompt 404 to the machine learning model 106.

The machine learning model 106 may be any artificial intelligence model that generates responses or predictions based on supplied input. For example, the machine learning model 106 may include a neural network and/or a large language model that responds to the prompt 404 by predicting a user action from the list 402 that, when performed, will dismiss or clear an element from the user interface. In the example of FIG. 4, the machine learning model 106 may analyze the identifiers 202, images 204, and locations 206 for the elements of the user interface, the image 302 of the user interface, the list 402 of user actions, and/or the image 304 of the user interface to make any number of predictions or determinations. For example, the machine learning model 106 may determine or predict that the first element corresponding to the identifier 202A, the image 204A, and the location 206A may prevent or block interaction with the user interface until the first element is dismissed or cleared from the user interface. The machine learning model 106 may also determine a user action 406 from the list 402 that, when performed on the first element, will dismiss or clear the first element from the user interface. The machine learning model 106 may output the user action 406 and/or identify the first element.

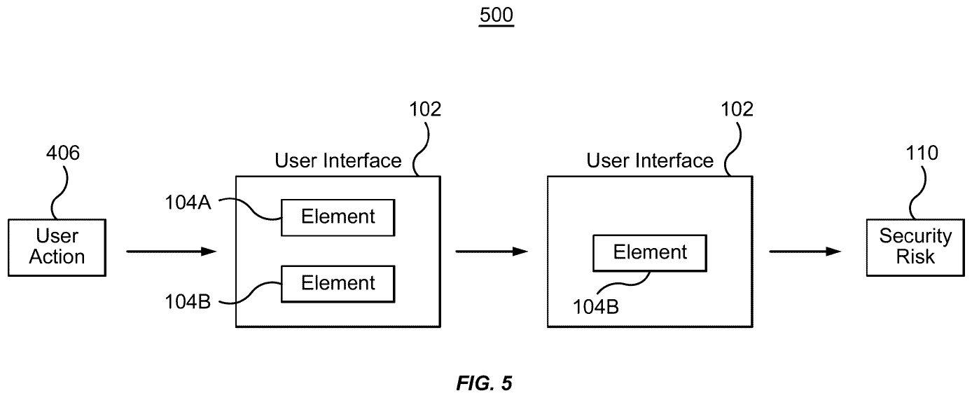

FIG. 5 illustrates an example operation for determining a security risk performed by a computer system (e.g., the computer system 800 shown in FIG. 7). The computer system begins with the user action 406 outputted by a machine learning model. In some instances, the machine learning model may also identify the element on which the computer system should perform the user action 406 to dismiss or clear the element.

As seen in FIG. 5, the computer system may perform the user action 406 on the element 104A of the user interface 102. For example, the user interface 102 may be a website, and the element 104A of the user interface 102 may be a button accompanied by a message or notification. If the machine learning model indicates that the user action 406 is a click and identifies the element 104A of the user interface 102 (e.g., using the identifier for the element 104A), then the computer system may simulate a click on the button. When the user interface 102 detects the click on the button, the user interface 102 may dismiss, clear, or remove the element 104A (e.g., the button and accompanying message or notification) from the user interface 102. As a result, the element 104B remains in the user interface 102 and the element 104A disappears from the user interface 102. Additionally, removing the element 104A may allow interaction with other portions of the user interface 102 (e.g., with the element 104B).

After the computer system dismisses the element 104A from the user interface 102, the computer system may scan or crawl the user interface 102. The scanning or crawling may simulate interactions with portions of the user interface 102 (e.g., with the elements of the user interface 102). By scanning or crawling with the user interface 102, the computer system may detect the security risk 110 presented by the user interface 102. If the computer system had not dismissed the element 104A from the user interface, the element 104A may have prevented the scanning or crawling on the user interface 102, and the computer system may have failed to detect the security risk 110. Thus, by using the machine learning model to determine the user action 406, the computer system allows the scanning or crawling to be performed successfully.

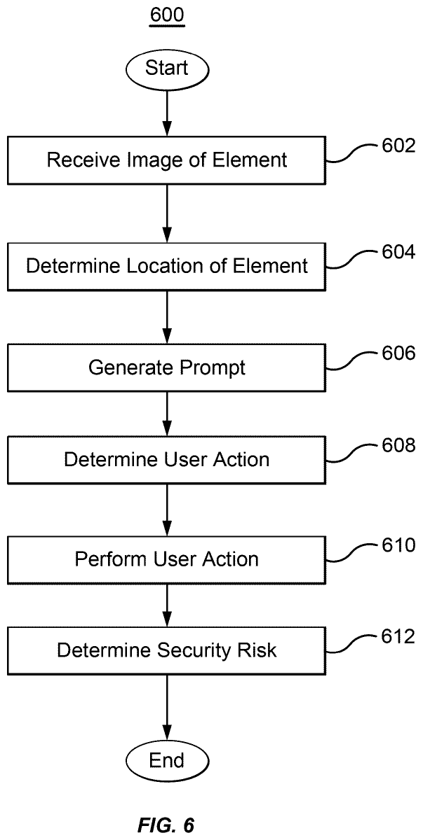

FIG. 6 is a flowchart of an example method 600 for determining a security risk performed by a computer system (e.g., the computer system 800 shown in FIG. 7). By performing the method 600, the computer system uses artificial intelligence to determine a user action to dismiss an element from a user interface such that the user interface may be scanned or crawled to detect a security risk.

At 602, the computer system receives an image of an element of a user interface. The element may include one or more of images, text, textboxes, buttons, lists, links, bars, etc. When the element is displayed or presented in the user interface, the element may block or prevent interactions with other portions (e.g., other elements) of the user interface. As a result, the element may prevent the computer system from scanning or crawling the user interface to detect a security risk presented by the user interface.

At 604, the computer system determines a location of the element in the user interface. For example, the computer system may determine coordinates or a path of the element in the user interface. As another example, the computer system may determine an XPath or CSS Selector of the element.

At 606, the computer system generates a prompt using the information about the user interface and/or the element. For example, the prompt may incorporate the image of the element and the location of the element in the user interface. The prompt may request that a machine learning model determine or predict, based on the image of the element and the location of the element, a user action that will dismiss or clear the element from the user interface.

At 608, the computer system determines the user action. For example, the computer system may direct the prompt to the machine learning model, and the machine learning model may analyze the information in the prompt to respond to the prompt. The machine learning model may determine, from the image of the element and the location of the element, the user action that, when performed, will dismiss the element from the user interface. As an example, the machine learning model may determine that the element includes a button and that if the button is clicked, the element will be dismissed.

At 610, the computer system performs the user action on the element (e.g., clicking the button of the element), which may dismiss or clear the element from the user interface. After dismissing or clearing the element, the user interface may allow interactions with other portions of the user interface. At 612, the computer system scans and crawls the user interface to determine a security risk presented by the user interface. For example, the computer system may simulate interactions with the user interface during the scanning and crawling process. By interacting with the user interface, the computer system may detect the security risk presented by the user interface.

FIG. 7 illustrates an example machine of a computer system 700 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM), a static memory 706 (e.g., flash memory, static random access memory (SRAM), etc.), and a data storage device 718, which communicate with each other via a bus 730.

Processing device 702 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 may be configured to execute instructions 726 for performing the operations and steps described herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a non-transitory computer-readable medium) on which is stored one or more sets of instructions 726 or software embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In some implementations, the instructions 726 include instructions to implement functionality corresponding to the present disclosure. While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 702 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A computer system for dismissing user interface elements, the computer system comprising:
one or more memories; and
one or more processors communicatively coupled to the one or more memories, the one or more processors configured to, individually or collectively, perform an operation comprising:
receiving an image of an element of a user interface;
determining a location of the element in the user interface;
determining, using a machine learning model and based on the image of the element and the location of the element in the user interface, a user action for dismissing the element from the user interface; and
performing the user action on the element to dismiss the element from the user interface.

2. The computer system of claim 1, wherein the operation further comprises receiving an image of the user interface comprising the element and wherein determining the user action is further based on the image of the user interface.

3. The computer system of claim 1, wherein the operation further comprises receiving a list of user actions and wherein determining the user action comprises selecting the user action from the list of user actions.

4. The computer system of claim 1, wherein the operation further comprises receiving an image of the user interface with the element dismissed and wherein determining the user action is further based on the image of the user interface with the element dismissed.

5. The computer system of claim 1, wherein determining the user action comprises:
generating a prompt based on the image of the element and the location of the element in the user interface; and
directing the prompt to the machine learning model.

6. The computer system of claim 1, wherein the user interface is a website.

7. The computer system of claim 1, wherein the operation further comprises scanning the user interface after dismissing the element to detect a security risk in the user interface.

8. The computer system of claim 1, wherein the element prevents interaction with a portion of the user interface until the element is dismissed from the user interface.

9. The computer system of claim 1, wherein the operation further comprises scanning the user interface to detect the element.

10. A method for dismissing user interface elements, the method comprising:
receiving an image of an element of a user interface;
determining a location of the element in the user interface;
determining, using a machine learning model and based on the image of the element and the location of the element in the user interface, a user action for dismissing the element from the user interface; and
performing the user action on the element to dismiss the element from the user interface.

11. The method of claim 10, further comprising receiving an image of the user interface comprising the element, wherein determining the user action is further based on the image of the user interface.

12. The method of claim 10, further comprising receiving a list of user actions, wherein determining the user action comprises selecting the user action from the list of user actions.

13. The method of claim 10, further comprising receiving an image of the user interface with the element dismissed, wherein determining the user action is further based on the image of the user interface with the element dismissed.

14. The method of claim 10, wherein determining the user action comprises:
generating a prompt based on the image of the element and the location of the element in the user interface; and
directing the prompt to the machine learning model.

15. The method of claim 10, wherein the user interface is a website.

16. The method of claim 10, further comprising scanning the user interface after dismissing the element to detect a security risk in the user interface.

17. The method of claim 10, wherein the element prevents interaction with a portion of the user interface until the element is dismissed from the user interface.

18. The method of claim 10, further comprising scanning the user interface to detect the element.

19. A non-transitory computer readable medium storing instructions for dismissing user interface elements that, when executed by one or more processors, cause the one or more processors to, individually or collectively, perform an operation comprising:
receiving a first image of an element of a website;
receiving a second image of the website comprising the element;
determining a location of the element in the website;
receiving a list of user actions;
determining, using a machine learning model and based on the first image, the second image, the location of the element in the website, and the list of user actions, a user action for dismissing the element from the website; and
performing the user action on the element to dismiss the element from the website.

20. The medium of claim 19, wherein determining the user action comprises:
generating a prompt based on the first image, the second image, the location of the element in the website, and the list of user actions; and
directing the prompt to the machine learning model.
